(19) United States
(12) Patent Application Publication
(10) Pub. No.: US 2004/0174856 A1
(43) Pub. Date: Sep. 9, 2004

(54) Method for transporting real-time data on a radio packet communication network

(76) Inventors: Jerome Brouet, Paris (FR); Nicolas Paul, Paris (FR); Carine Thirouard, Gif sur Yvette (FR)

Correspondence Address: SUGHRUE MION, PLLC, 2100 PENNSYLVANIA AVENUE, N.W., SUITE 800, WASHINGTON, DC, 20037, US

(21) Appl. No.: 10/483,397

(22) PCT Filed: Jul. 31, 2001
(86) PCT No.: PCT/EP01/08700

(51) Int. Cl. H04J 3/24; H04Q 7/00

(52) U.S. Cl. 370/349; 370/328

(57) ABSTRACT

The present invention relates to a method for transporting real-time data from a transmitter to a receiver on a radio packet communication network, said method comprising the steps of:

generating, at said transmitter, real-time data frames, said time real-data frames comprising at least two bit portions;

selecting said first bit portion and submitting it to a first modulation and coding scheme providing an error-resistance higher than an error-resistance threshold;

selecting said second bit portion and submitting it to a second modulation and coding scheme providing an error-resistance lower than said error-resistance threshold;

transmitting a first radio packet transmission unit corresponding to said first bit portion to said receiver;

transmitting a second radio packet transmission unit corresponding to said second bit portion to said receiver, said second radio packet transmission unit being different from said first radio packet transmission unit.

### BACKGROUND OF THE INVENTION

The present invention relates to radio packet communication networks and more precisely to a method for transporting real-time data as compressed voice or compressed video in such networks.

Radio packet communication networks, such as GPRS (General Packet Data Services) or EDGE (Enhanced Data rate for GSM Evolution) networks, at the origin thought for the transmission of pure data, have been adapted to the transmission of real time services as voice services.

In radio packet communications networks, no physical connection is established for the whole duration of the conversation as in circuit oriented radio communication network as GSM, where fixed time slots are allocated in each frame for each user.

On the contrary, in radio packet communications networks, specific medium access mechanisms control dynamically the allocation of resource (i.e time slot in a frame and frequency) to the different users depending on their needs.

This presents the advantage of a higher network capacity. Indeed, when users have nothing to transmit other users can be allocated the transmission medium. On the other hand, however, specific additional features must be implemented to comply with the specificity of voice and video services.

One of this specificity consists in that the voice frame at the output of a voice codec comprises bits having different relevance. As shown on FIG. 1, a 20 ms speech sample 10 is encoded by using a voice codec 11 usually a GSM fullrate codec (13 Kbps) compliant with the specification GSM TS 06.10. A voice frame 12 is obtained at the output of codec 11 and comprises 260 bits divided in three bit portions 50 class A bits, 132 class B bits and 78 class C bits. The different bit portions are also referred as Class Ia, Class Ib and Class II respectively in the GSM context. Class A and B bits are the most relevant bits describing the voice frame. The correct reception of class A bits is essential to reconstruct the voice frame at the receiver side while errors on class B and class C bits can be tolerated.

A solution implemented in usual GSM circuit oriented networks is presented on FIG. 2. It takes into account the different relevance of the different class of bits, while not increasing too much the redundancy, and consists in applying unequal error protections to the different portions class A, Class B, Class C of the voice frame 12. Unequal error protection consists in protecting more the class A and B than the class C bits. The class A and B bits as for this purpose submitted to a convolutional encoding (step 22) while the class C are sent without any protection. To protect class A bits even more and ensure error detection at the receiver in case of propagation errors on the radio link, a checksum CRC is appended (step 21) at the end of the class A bits. Then, interleaving (step 23) is performed to maximize to decoding capability on the convolutional decoder at the receiver side and the resulting TDMA frames are modulated and transmitted on a radio communication channel (step 24) i.e. a traffic channel TCH.

This solution is however not applicable to radio packet communication networks as GPRS or EDGE designed for the transport of data where each bit as similar importance. Hence, on a packet radio channel of such radio packet communication network, each bit is equally protected. As a consequence, class A bits are not enough protected while Class C bits are over protected. This, has the disadvantage to cause a degradation of the voice quality in such radio packet communication networks. If a protection adapted to the requirements of class A bits is used for the whole voice frame, the voice quality will be ensured but the redundancy due to the high overhead of the protection will cause very poor performance of the system.

Some solutions to this problem consist in developing new modulation and coding schemes more efficient than the ones already specified for the radio packet communication network. A example of a new modulation and coding scheme is given in the article “Transmission of voice in an EDGE Network” Wu and al. From the Bell Labs which should be added to the nine already defined modulation and coding schemes of EDGE.

A particular object of the present invention is to provide an alternative method for transporting of real-time data (e.g. voice, video) in a radio packet communication with a good quality while optimizing the performances of the system in terms of data redundancy.

Another object of the invention is to provide a transmitter of a radio packet communication network implementing a such method and a receiver adapted to receive signal transmitted according to the present invention.

### SUMMARY OF THE INVENTION

These objects, and others that appear below, are achieved by a method for transporting real-time data from a transmitter to a receiver on a radio packet communication network according to claim 1, a transmitter according to claim 8 and a receiver according to claim 9.

According to the present invention, different modulation and coding schemes are used for the different bit portions of the real-time data frame, the modulation and coding scheme being chosen according to the relevance of the bits contained in the different bit portions. Then, the encoded and modulated bit portions are transmitted in different predefined radio packets transmission units.

At the receiver side, the counterpart method is applied, data are extracted from predefined radio packet transmission units. The data corresponding to the different bit portions are demodulated, decoded with the appropriate modulation and coding scheme and the real-time data frame is reconstituted and submitted to a codec.

The method according to the present invention presents the advantage to increase the quality of the transmitted real-time data while not overprotecting the less relevant bits. Indeed, a radio packet transmission unit using a modulation and coding scheme having a very high error-resistance will be chosen for transporting the bit portion comprising the most relevant bits (e.g. Class A bits) while another radio packet transmission unit associated to a less error-resistant modulation and coding scheme will be used for transporting the less relevant bits of the real-time data frame (e.g. Class C bits).

The method according to the present invention presents further the advantage to reuse usual modulation and coding schemes already defined in the radio packet communication network standard.

In a preferred embodiment of the present invention, bit portions belonging to at least two real-time data frames will be multiplexed before being submitted to the modulation and coding scheme.

This embodiment presents moreover the advantage of providing a delay for the transmission of voice between the transmitter and the receiver similar to the delay in a GSM network.

Further advantageous features of the invention are defined in the dependent claims.

### BRIEF DESCRIPTION OF THE DRAWINGS

Other characteristics and advantages of the invention will appear on reading the following description of a preferred embodiment given by way of non-limiting illustrations, and from the accompanying drawings, in which:

FIG. 1 shows a usual method for coding speech samples with a voice codec and the format of the corresponding voice frame at the output of the codec;

FIG. 2 shows a prior art method used for transporting compressed voice in a circuit-oriented radio communication network using unequal error protection;

FIG. 3 illustrates an embodiment of the method for transporting real-time data in a radio packet communication network according to the present invention;

FIG. 4 illustrates a second embodiment of the method for transporting real-time data in a radio packet communication network according to the present invention;

FIG. 5 represents an embodiment of a transmitter according to the present invention to be used in a radio packet communication network;

FIG. 6 represents an embodiment of a receiver according to the present invention to be used in a radio packet communication network.

### DETAILED DESCRIPTION OF THE INVENTION

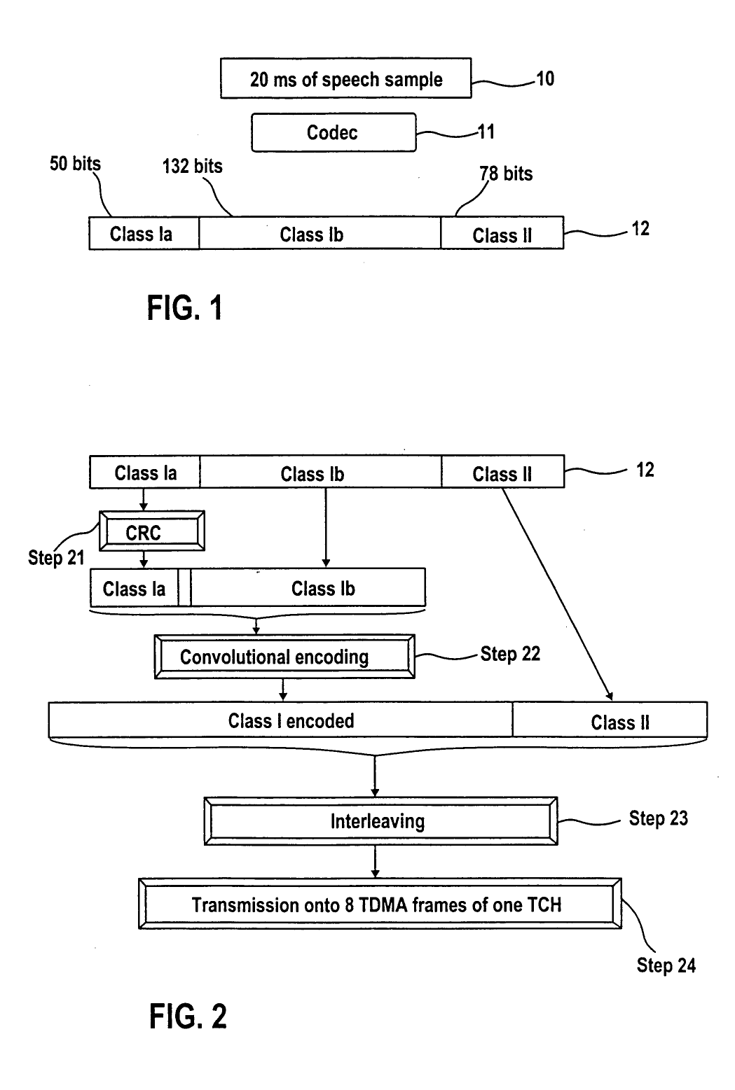

FIG. 1 and FIG. 2 have already been described in connection with prior art.

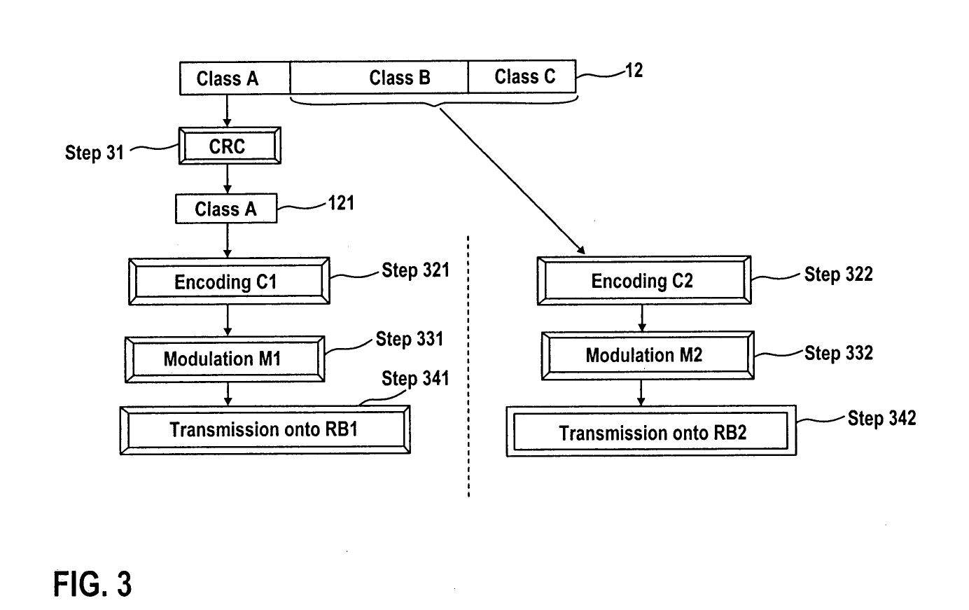

FIG. 3 illustrates an embodiment of the method for transporting real-time data in a radio packet communication network according to the present invention. In this embodiment real-time data consists in compressed voice, obtained as already described on FIG. 1. A voice frame 12 comprises three bit portions Class A, Class B, Class C. Class A comprises the most relevant bits of voice frame 12.

Class A bit portion and the group consisting in class B and class C bit portions are handled in parallel: class A bit portion is submitted to steps 31, step 321, step 331 and step 341, while class B and Class C bit portions are be submitted to step 322, step 332 and step 342.

Step 31 consists in appending a checksum to the class A bit to increase the error protection of this high relevant bit portion. The checksum may correspond to any well-known Cyclic Redundancy Check mechanism. An intermediary data entity 121 is obtained and submitted to step 321.

Step 31 is however not mandatory in the framework of the present invention.

Step 321 consists in encoding data entity 121 with a first encoding scheme presenting a coding rate C1. A convolutional encoding preferably used.

Step 331 consists in modulating the encoded data with a first modulation scheme presenting a modulation efficiency M1.

At step 341, the modulated data are transmitted in a first radio radio packet transmission unit RB1.

Class B and Class C bit portions are similarly encoded at step 322 with a coding scheme presenting a coding rate C2 and modulated with a modulation scheme presenting a modulation efficiency M2 and transmitted in a second radio packet transmission unit RB2 different from RB1.

The term radio packet transmission unit, also called radio block RB1, RB2 in some known radio packet communication networks as EDGE, refers to a data container characterized by its type i.e. a predefined modulation and coding scheme used for coding and modulating the data contained in this container. Such radio packet transmission units are transmitted on a physical radio channel (PDCH). Radio packet data units having different type may be transmitted on the same physical radio channel. In the frame work of the present invention, the radio packet data units corresponding to the first portions of the real-time frame and the radio packet data units corresponding to the second portions of the real-time frame may be transmitted on the same physical radio channel or alternatively on different physical radio channels.

The coding rate C1, C2 of a coding scheme corresponds to the ratio between the number of bits at the input of the encoder and the number of bits at the output of the encoder. A coding scheme with a low coding rate generate a high overhead in the coded data and is as a consequence more error-resistant than a coding scheme with a higher coding rate.

The modulation efficiency M1, M2 of a modulation scheme correspond to the number of data bit per modulation symbols. The higher the number of bit per modulation symbols, the more efficient the modulation. Indeed, a modulation with a low efficiency will be used to modulate bit portions which need to be very error-resistant as class A bits for example.

The effects of the modulation schemes and of the coding schemes regarding the error-resistance of data must be considered together. Indeed, they may compensate each other or reinforce each other.

As a consequence, the error resistance is evaluated for a couple modulation scheme/coding scheme. One or more error-resistance threshold may be defined to determine which modulation and coding scheme correspond to which degree of error resistance. Such an error resistance threshold may be expressed by means of a bit error rate or any similar quantity.

As well the couple modulation scheme/coding scheme also determine the maximum efficient data rate which can be transmitted on a radio channel. Such couples modulation scheme/coding scheme (MCS) are defined in the specification of the EDGE radio packet communication network. They are presented in the following table by increasing error-resistance.

| | | Coding | Max eff. bit |
|---|---|---|---|
| | Modulation scheme | rate | rate Kbit/s |
| MCS9 | 8PSK(mod. eff. = 3) | 1 | 59.2 |
| MCS8 | 8PSK | 0.92 | 54.4 |
| MCS7 | 8PSK | 0.76 | 44.8 |
| MCS6 | 8PSK | 0.49 | 29.6 |
| MCS5 | 8PSK | 0.37 | 22.4 |
| MCS4 | GMSK(mod. eff. = 1) | 1 | 17.6 |
| MCS3 | GMSK | 0.8 | 14.8 |
| MCS2 | GMSK | 0.66 | 11.2 |
| MCS1 | GMSK | 0.53 | 8.8 |

Moreover, in EGDE radio packet communication network, each radio packet communication channel is characterized by the couple modulation and coding scheme used for the transport of data on this channel.

In a preferred embodiment of the present invention applied to an EDGE radio packet communication network, class A bit portions are transmitted in a radio packet transmission unit using MCS1 and class B and Class C bit portion transmitted in a radio packet transmission unit using MCS 5.

The present invention may be used in TDMA (Time Division Multiple Access)-based radio packet communication systems as EDGE but is not limited to those. The present invention may also be used in CDMA (Code Division Multiple Access)-based as well as on OFDM (Orthogonal Frequency Division Multiplexing)-based wireless communication systems or any other radio packet communication systems when transmitting real-time data as compressed voice or compressed video.

Preferably, the data are interleaved onto several frames between the encoding steps 321, 322 and the modulation steps 331, 332 to maximize the encoding capability of the decoder at the receiver side. Interleaving is however not mandatory in the framework of the present invention.

Although, Class B bits are more relevant than Class C bits, for sake of simplicity in the illustrated embodiment of the method according to the present invention, these two bit portions are handled as if they where of identical relevance. It will be clear for a person skilled in the art, that class B and class C bit portions could also be handled separately, each bit portion being submitted to two different modulation and coding schemes and transmitted in two different radio packet transmission units.

It will also be clear for a person skilled in the art, that the method according to the present invention can be applied for any input data structure presenting any number of bit portions having different relevance. The invention is, as a consequence, not limited to the use of the method in the case of voice frames presenting three different bit portions obtained with a full rate GSM codec. The invention can be used for voice frame obtained with an half rate codec or for transporting video data also coded so as to present several bit portions with different relevance. Such a codec for video can for example be compliant with the MPEG 4 format.

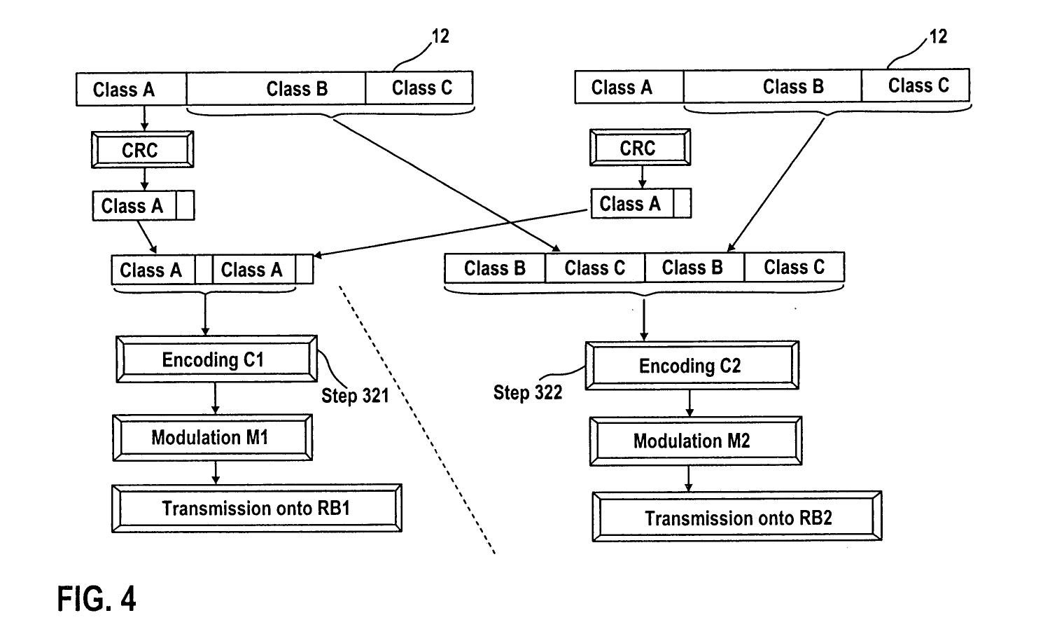

FIG. 4 represents a second embodiment of a method for transporting real-time data according to the present invention to be used in a radio packet communication network.

This embodiment consists in multiplexing bit portions of several real-time data frames 12 before the encoding steps 321, 322. On FIG. 4, the multiplexing of Class A respectively class B bit portions of two consecutive frames 12 is illustrated. The consecutive voice frames 12 may belong to the same user (usually in the uplink) or to different users (as it may be the case in the downlink).

It will also be clear for a person skilled in the art, that this embodiment of the present invention is not limited to the multiplexing of bit portions of two voice frames. This is however a preferred embodiment if a full-rate GSM codec is used for generating the voice frames. This embodiment presents the advantage of providing a data delay between the transmitter and the receiver similar to the data delay experienced in usual GSM networks. Indeed two voice frames are transmitted onto 8 TDMA frames: 4 TDMA frames for the class A bit portions and 4TDMA frames for the class B, class C bit portions.

In case of a half-rate GSM codec, the multiplexing of up to 4 voice frames may be envisaged.

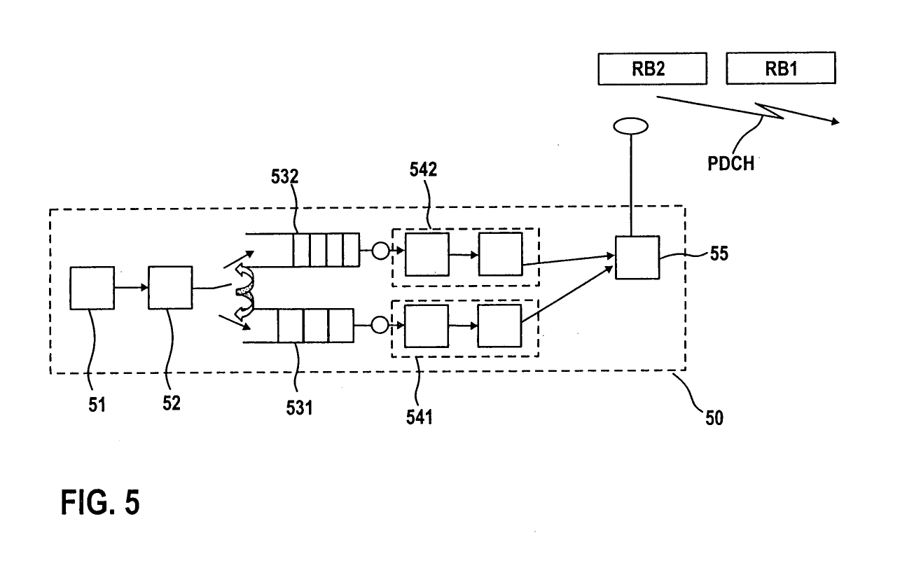

FIG. 5 represents an embodiment of a transmitter 50 according to the present invention to be used in a radio packet communication network. Transmitter 50 comprises a codec 51, a segmenting module 52, two data queues 531, 532, two modulation and coding schemes 541, 542 and a transmission module 55.

Codec 51 is preferably GSM full-rate codec encoding speech sample in voice frames comprising at least two bit portions of different relevance.

Segmenting module 52 is dedicated for selecting from each voice frame the different bit portions and storing them in the corresponding data queues 531, 532. One data queue is allocated for each different bit portion. In the example, two data queues 531, 532 are provided for storing two different type of bit portions.

Transmitter 50 further comprises as many modulation and coding chains 541, 542 as data queue 531, 532 and each takes as input data out of a predefined data queue. A modulation and coding chain 541, 542 comprises an encoder preferably a convolutional encoder having a predefined coding rate and a modulator having a predefined modulation efficiency. Depending on the coding rate and the modulation efficiency, a error-resistance indicator is determined for each modulation and coding scheme. The data queue containing the bit portions with the higher relevance is connected to the modulation and coding chain with the higher error-resistance indicator.

The output of modulation and coding chains 541, 542 is connected to transmission module 55 which maps the modulated signals coming from the different modulation chains in different predefined radio packet transmission units RB1, RB2.

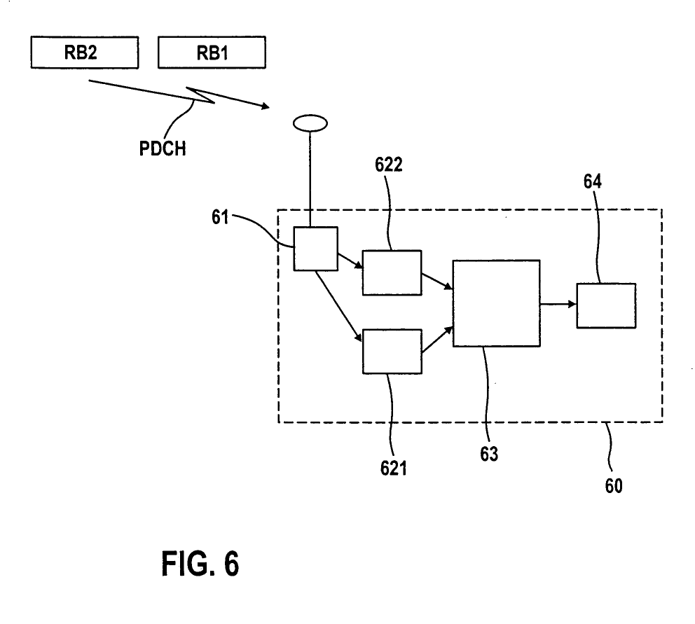

FIG. 6 represents an embodiment of a receiver 60 according to the present invention to be used in a radio packet communication network. Receiver 60 comprises a module for receiving in parallel data signals carried in predefined radio packet transmission units RB1, RB2. The signal received in a given radio packet transmission unit RB1, RB2 is submitted to a predefined demodulation and decoding chains 621, 622. Then, the output of the different demodulation and decoding chains 621, 622 are combined together at combining module 63 according to a predefined format to form an herein called reconstituted voice frame which is then submitted to codec 64. At the output of codec 64, the speech samples are reconstituted.

In order for a system comprising a plurality of transmitters and receiver according to the present invention to work efficiently, the voice frame format delivered by the codecs 51, 64 must be known at both the transmitter 50 and the receiver 60 for the segmenting module 52 and the combining module 63 to be able to proper segment and reconstituted the voice frames.

Moreover, the modulation and coding schemes (M1, M2, C1, C2) used for the different bit portions (class A, class B, class C) and the radio packet transmission unit type on which they are transmitted must also be known at both transmitter 50 and receiver 60. These parameters may be fixed for the system and hard coded in transmitter 50 and receiver 60.

Alternatively, at call set up these parameters may be negotiated between transmitter 50 and receiver 60.

In a further embodiment of the present invention, these parameters may also be updated dynamically depending on the current propagation conditions on the radio link. For example for bad propagation conditions MCS1 is used for class A bits resp. MSC5 for class B, class C bits while when the propagation conditions improves, MCS2 resp MCS6, may be used. This change would according to the present invention necessitate the change of radio packet transmission unit each time the modulation and coding schemes are modified to fit the radio link quality. A threshold may be defined to determine up to which radio link quality which modulation and coding schemes are used for which bit portions.

1\ Method for transporting real-time data from a transmitter to a receiver on a radio packet communication network comprising the steps of:
generating, at said transmitter, real-time data frames (12) by using a codec (11), said time real-data frames comprising at least two bit portions (class A, class B, class C);
selecting said first bit portion (class A) and submitting it to a first modulation and coding scheme (M1, C1) providing an error-resistance higher than an error-resistance threshold;
selecting said second bit portion (class B, class C) and submitting it to a second modulation and coding scheme (M2, C2) providing an error-resistance lower than said error-resistance threshold;
transmitting a first radio packet transmission unit (RB1) corresponding to said first bit portion to said receiver;
transmitting a second radio packet transmission unit (RB2) corresponding to said second bit portion to said receiver, said second radio packet transmission unit (RB2) being different from said first radio packet transmission unit (RB1).

2\ Method according to claim 1, in that said real-time data frames are compressed voice or video frames (12) generated by a voice or video codec (11), said compressed voice frames or compressed video frames comprising at least two bit portions (class A, class B, class C), a first bit portion (class A) comprising bits having a relevance higher than a predefined relevance threshold and a second bit portion (class B, class C) comprising bits having a relevance lower than said predefined relevance threshold.

3\ Method according to claim 1, further comprising the step of appending a checksum (CRC) to said first bit portion (class A) before submitting it to said first modulation and coding scheme (M1, C1).

4\ Method according to claim 1, further comprising the step of multiplexing bit portions belonging to at least two real-time data frames before submitting them to said modulation and coding scheme (M1, C1, M2, C2).

5\ Method according to claim 1, further comprising the steps of agreeing at said transmitter (50) and at said receiver (60) upon
the format of said real-time data frames;
said first and second modulation and coding schemes (M1, C1, M2, C2) used for the different bit portions of said real-time data frame.

6\ Method according to claim 5, further comprising the step of updating said first and second modulation and coding schemes (M1, C1, M2, C2) according to the current radio link quality.

7\ Method according to claim 1 used in an Enhanced Data rate for GSM Evolution EDGE network, said first and second modulation and coding schemes being chosen in the group of modulation and coding schemes defined in EDGE specification.

8\ Transmitter (50) adapted to be used for the transmission of real-time data on a radio packet communication network, said transmitter (50) comprising:
a codec (51) for generating real-time data frames (12), said real-time frames (12) comprising at least two bit portions (class A, class B, class C);
a module (52) for selecting a first bit portion and a second bit portion of said real-time data frame and storing them in a first data queue (531) and in a second data queue (532) respectively;
a first modulation and coding chain (541) for modulating and coding data stored in said first data queue (531) according to a first modulation and coding scheme (M1, C1) providing an error-resistance higher than an error-resistance threshold;
a second modulation and coding chain (542) for modulating and coding data stored in said second data queue (532) according to a second modulation and coding scheme (M2, C2) providing an error-resistance lower said error-resistance threshold;
a transmission module (55) for transmitting a first radio packet transmission unit (RB1) corresponding to said first bit portion and a second radio packet transmission unit (RB2) corresponding to said second bit portion on said radio packet communication network.

9\ Receiver (60) adapted to be used for the reception of real-time data transmitted on a radio packet communication network according to the method of claim 1, said receiver (60) comprising:
a module (61) for demodulating and decoding at least two types of radio packet transmission units (RB1, RB2) received at said receiver (60) by using at least two different predefined demodulation and decoding schemes (M1, C1, M2, C2);
a module (63) for combining in a data entity herein called, reconstituted real-time frame, a first predefined part of a radio packet transmission unit of a first type with a second predefined part of a radio packet transmission units of a second type;
a codec (64) for decoding said reconstituted real-time data frame.
